(19) United States
(12) Patent Application Publication
(10) Pub. No.: US 2024/0175468 A1
(43) Pub. Date: May 30, 2024

(54) METHOD AND DEVICE FOR FAULT DIAGNOSIS OF A SLIDING BEARING IN ROTATING MACHINERY

(71) Applicant: Aktiebolaget SKF, Göteborg (SE)

(72) Inventors: Kaihuan Zhang, Hangzhou (CN); Shuo Yao, Shanghai (CN); Gang Cheng, Shanghai (CN)

(21) Appl. No.: 18/513,904

(22) Filed: Nov. 20, 2023

(30) Foreign Application Priority Data
Nov. 28, 2022 (CN) 202211500156.7

(51) Int. Cl. F16C 41/00; G01M 13/04

(52) U.S. Cl. CPC F16C 41/00; G01M 13/04; F16C 2233/00

(57) ABSTRACT

The present disclosure provides a method and device for fault diagnosis of a sliding bearing in rotating machinery. The method includes obtaining a signal data set of displacement signals of shaft vibration of the sliding bearing in the rotating machinery, classifying and archiving the displacement signals of the shaft vibration in the signal data set according to fault types, synthesizing the displacement signals in the archived signal data set to obtain a plot of shaft center orbit of the sliding bearing in the rotating machinery, so as to obtain a plot data set of the shaft center orbit, and training the fault diagnosis model based on the plot data set of the shaft center orbit.

### CROSS-REFERENCE TO RELATED APPLICATION

This application claims priority to Chinese Application No. 202211500156.7, filed Nov. 28, 2022, the entirety of which is hereby incorporated by reference.

### FIELD

The present disclosure relates to the field of information technology, in particular, to a method and device for fault diagnosis of a sliding bearing in rotating machinery.

### BACKGROUND

Rotating machinery can refer to the machinery whose main function is performed by rotating motion, especially refer to the machinery whose main components rotate in high speed. Common rotating machinery includes steam turbines, gas turbines, centrifugal compressors, generators, water pumps, hydraulic turbines, ventilators, electric motors, and so on, whose main components can include rotors, bearings, stators, and so on.

Taking rotating machinery including sliding bearings as an example, malfunctions or failures may occur due to overload, poor lubrication, improper assembly or impact.

For different failure types, the signals obtained from sliding bearings in rotating machinery can have different characteristics. By identifying these characteristics, faults of sliding bearings in rotating machinery can be diagnosed.

### SUMMARY

The following provides a brief summary of the disclosure in order to provide a basic understanding of some aspects of the disclosure. It is to be understood, however, that this summary is not an exhaustive overview of the disclosure. It is intended neither to identify key or critical parts of the disclosure nor to limit the scope of the disclosure. The purpose is merely to present some concepts of the disclosure in a simplified form as a prelude to the more detailed description presented hereinafter.

According to a first aspect of the present disclosure, a method for establishing a fault diagnosis model for a sliding bearing in rotating machinery is provided, comprising: obtaining a signal data set of displacement signals of shaft vibration of the sliding bearing in the rotating machinery; classifying and archiving the displacement signals of the shaft vibration in the signal data set according to fault types; synthesizing the displacement signals in the archived signal data set to obtain a plot of shaft center orbit of the sliding bearing in the rotating machinery, so as to obtain a plot data set of the shaft center orbit; and training the fault diagnosis model based on the plot data set of the shaft center orbit.

In preferred embodiments according to the present disclosure, the signal data set includes at least one of a set of simulated data and a set of condition monitoring data, the set of simulated data includes data obtained by virtual measurements with simulated measurement directions that are orthogonal to each other, and the set of the condition monitoring data includes data obtained by two sensors with measurement directions that are orthogonal to each other.

In preferred embodiments according to the present disclosure, training the fault diagnosis model based on the plot data set of the shaft center orbit comprises: extracting a set of signal features based on the archived signal data set, and extracting a set of signal features based on the plot data set of the shaft center orbit; and training the fault diagnosis model based on the extracted set of the signal features and the extracted set of the image features.

In preferred embodiments according to the present disclosure, training the fault diagnosis model based on the extracted set of signal features and the extracted set of the image features comprises: performing machine learning modeling and deep learning modeling based on the extracted set of signal features and the extracted set of the image features; fusing a machine learning model and a deep learning model to obtain the fault diagnosis model.

According to a second aspect of the present disclosure, a method for fault diagnosis of a sliding bearing in rotating machinery is provided, comprising: obtaining displacement signals of shaft vibration of the sliding bearing in the rotating machinery to be diagnosed; synthesizing the displacement signals of the shaft vibration to obtain a plot of shaft center orbit of the sliding bearing in the rotating machinery to be diagnosed; utilizing a fault diagnosis model to diagnose the fault type of the sliding bearing in the rotating machinery to be diagnosed, based on the plot of the shaft center orbit of the sliding bearing in the rotating machinery to be diagnosed.

In preferred embodiments according to the present disclosure, in case the fault diagnosis model is a machine learning model, a deep learning model, or a fusion model thereof, the method further includes: extracting signal features based on the displacement signals of the shaft vibration, and extracting image features based on the plot of the shaft center orbit; and inputting the extracted signal features and image features into the fault diagnosis model to diagnose the fault type of the sliding bearing in the rotating machinery to be diagnosed.

According to a third aspect of the present disclosure, a device for establishing a fault diagnosis model of a sliding bearing in rotating machinery is provided, comprising: an orbit data set obtaining module configured to obtain a signal data set of displacement signals of shaft vibration of the sliding bearing in rotating machinery; an orbit data set processing module configured to: classify and archive the displacement signals of the shaft vibration in the signal data set according to fault types, and synthesize the displacement signals in the archived signal data set to obtain a plot of shaft center orbit of the sliding bearing in the rotating machinery, so as to obtain a plot data set of the shaft center orbit; and an orbit identification modeling module configured to train the fault diagnosis model based on the plot data set of the shaft center orbit.

According to a fourth aspect of the present disclosure, a device for fault diagnosis of a sliding bearing in rotating machinery is provided, comprising: an orbit data obtaining module configured to obtain displacement signals of shaft vibration of the sliding bearing in the rotating machinery to be diagnosed; an orbit data processing module configured to synthesize the displacement signals of the shaft vibration to obtain a plot of shaft center orbit of the sliding bearing in the rotating machinery to be diagnosed; and an orbit analyzing module configured to utilize a fault diagnosis model to diagnose the fault type of the sliding bearing in the rotating machinery to be diagnosed, based on the plot of the shaft center orbit of the sliding bearing in the rotating machinery to be diagnosed.

According to a fifth aspect of the present disclosure, a device for fault diagnosis of a sliding bearing in rotating machinery is provided, including: a memory having computer instructions stored thereon; and a processor, wherein the instructions, when executed by the processor, cause the processor to perform the method according to the first or second aspect of the present disclosure.

According to a sixth aspect of the present disclosure, a non-transitory computer-readable storage medium is provided, storing instructions that cause a processor to perform the method according to the first or second aspect of the present disclosure.

Utilizing the methods and devices provided by the present disclosure, image features and signal features can be advantageously used to perform automatic fault diagnosis of a sliding bearing in rotating machinery more accurately and flexibly.

### BRIEF DESCRIPTION OF THE DRAWINGS

The present disclosure will become clearer and more readily understood from the following detailed description of embodiments of the present disclosure in conjunction with the accompanying drawings, in which:

FIG. 1 shows a flow chart of a method for establishing a fault diagnosis model for a sliding bearing in rotating machinery according to embodiments of the present disclosure;

FIG. 2 shows waveforms of displacement signals of a rotating shaft of a sliding bearing in rotating machinery in two directions of the x-axis and the y-axis according to embodiments of the present disclosure;

FIG. 3 shows a plot of the shaft center orbit of a sliding bearing in rotating machinery obtained by synthesizing displacement signals in two directions of x-axis and y-axis shown in FIG. 2 according to embodiments of the present disclosure;

FIG. 4A-FIG. 4D show plots of the shaft center orbits of a sliding bearing in rotating machinery with four types of typical faults;

FIG. 5 shows a flowchart of a method for fault diagnosis of a sliding bearing in rotating machinery according to embodiments of the present disclosure;

FIG. 6 shows a diagram of a device for establishing a fault diagnosis model for a sliding bearing in rotating machinery according to embodiments of the present disclosure;

FIG. 7 shows a diagram of a device for fault diagnosis of a sliding bearing in rotating machinery according to embodiments of the present disclosure;

FIG. 8 shows a diagram of a device for fault diagnosis of a sliding bearing in rotating machinery according to embodiments of the present disclosure.

It is to be understood that the accompanying drawings are provided for further understanding of the embodiments of the present disclosure, constitute portions of the specification to explain the present disclosure together with the embodiments of the present disclosure, and do not constitute a limitation of the present disclosure. Furthermore, in the accompanying drawings, the same reference numeral generally represents the same component or step.

### DETAILED DESCRIPTION

In order to better explain the technical solutions of the present disclosure, the present disclosure will be further described in detail below in conjunction with the accompanying drawings and specific embodiments. It is to be understood that based on the embodiments described in the present disclosure, all other embodiments obtained by those skilled in the art without creative efforts should fall within the protection scope of the present disclosure, and the embodiments described herein are only some of the embodiments of the present disclosure, rather than all the embodiments of the present disclosure. These embodiments are just illustrative and exemplary, and therefore should not be construed as limiting the scope of the present disclosure.

Common fault diagnosis methods for sliding bearings in rotating machinery include vibration analysis and orbit analysis. Fault diagnosis methods usually include the steps of collecting signals, extracting fault features based on the collected signals, and identifying operating faults based on the extracted fault features, where extracting fault features is usually through signal analysis, and the extracted features are relatively simple, which does not make full use of the signal data. Fault diagnosis methods usually rely on the knowledge and experience of experts for analysis, which utilizes artificial means and has relatively large limitations. In addition, the output format and performance of the existing fault diagnosis methods are also greatly limited.

In order to overcome the problems in the prior art, the present disclosure provides a method for establishing a fault diagnosis model for a sliding bearing in rotating machinery, a method for fault diagnosis of a sliding bearing in rotating machinery, a device for fault diagnosis of a sliding bearing in rotating machinery and a non-transitory computer-readable storage medium.

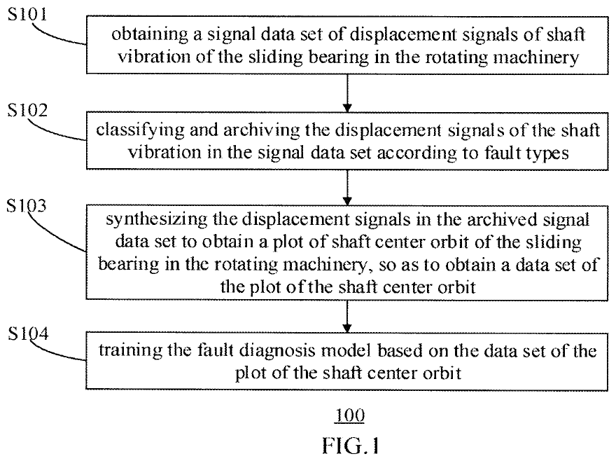

FIG. 1 shows a flowchart of method 100 for establishing a fault diagnosis model for a sliding bearing in rotating machinery according to embodiments of the present disclosure.

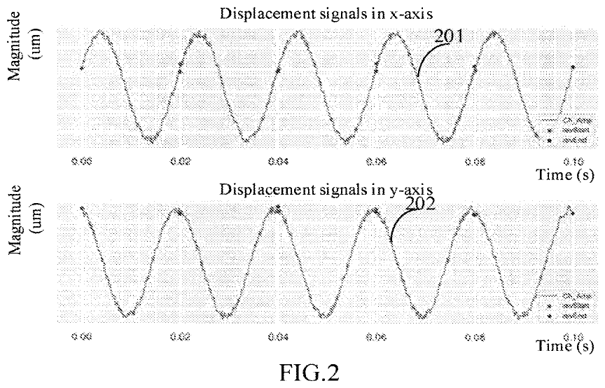

As shown in FIG. 1, at S101, a signal data set of displacement signals of shaft vibration of the sliding bearing in the rotating machinery can be obtained. The displacement signals of the shaft vibration can refer to the time-varying displacements of the vibration of the shaft center of the sliding bearing in the rotating machinery obtained by the sensor, a non-limiting example of which can be seen in FIG. 2.

FIG. 2 shows waveforms of displacement signals of a rotating shaft of a sliding bearing in rotating machinery in two directions of the x-axis and y-axis according to embodiments of the present disclosure. Waveforms 201 and 202 in FIG. 2 are time-domain signal waveforms. Waveform 201 shows the displacement of the rotating shaft of the sliding bearing in the rotating machinery in the x-axis direction as a function of time, where the horizontal axis represents time and the vertical axis represents displacement magnitude. Waveform 202 shows the displacement of the rotating shaft of the sliding bearing in the rotating machinery in the y-axis direction as a function of time, where the horizontal axis represents time and the vertical axis represents displacement magnitude. Waveforms 201 and 202 can be waveforms of the shaft displacement signals respectively obtained by two displacement sensors, and the measurement directions of the two displacement sensors are orthogonal to each other, so as to obtain displacement signals of the shaft vibration in two orthogonal directions. As a non-limiting example, in case the main rotating part of the rotating machinery is a sliding bearing, the sensor can be a proximity sensor mounted on the outer ring of the sliding bearing, such as an eddy current sensor.

In the present disclosure, a set of condition monitoring data can include actually measured displacement data of the shaft vibration obtained by two sensors whose measurement directions are orthogonal to each other. The actually-measured displacement data of the shaft vibration obtained based on several groups of condition monitoring can be archived as a set of the condition monitoring data [X_{c}, Y_{c}], where in each group of the condition monitoring, a group of the condition monitoring data x_{c} and y_{c} is obtained by two sensors orthogonal to each other, and the group of the condition monitoring data x_{c} and y_{c} are the actual values of the displacement signals x_{c}(t) and y_{c}(t) of the shaft vibration at a certain time instant. In the present disclosure, archiving can refer to sorting and summarizing data according to certain standards.

Considering that it is relatively difficult to obtain the actual condition monitoring data under the actual operating conditions on-site, in the embodiments of the present disclosure, in addition to or instead of the set of the condition monitoring data composed of the actual condition monitoring data, the signal data set can include a set of simulated data, where the set of simulated data can include simulated displacement data of the shaft vibration obtained by virtual measurements with orthogonal measurement directions, so as to enrich the data set with simulated data and enhance data training models. Specifically, the simulated displacement signals of the shaft vibration can be generated by the following orbit generation mechanism:

$${x}_{v} ( t ) = {a}_{1} sin ( {ω}_{1} t + {φ}_{1} ) + {a}_{2} sin ( 2 {ω}_{1} t + {φ}_{2} ) \qquad ( 1 )$$

$${y}_{v} ( t ) = {b}_{1} cos ( {ω}_{2} t + {θ}_{1} ) + {b}_{2} cos ( 2 {ω}_{2} t + {θ}_{2} )$$

where ω₁ and ω₂ can be the representative frequencies of the simulated displacement signals xᵥ(t) and yᵥ(t) of the shaft vibration, and a₁, a₂, φ₁, φ₂, b₁, b₂ can be the representative amplitudes and initial phases of the simulated displacement signals xᵥ(t) and yᵥ(t) of the shaft vibration. Specifically, for different fault types, the known ranges of the corresponding parameters ω₁, ω₂, a₁, a₂, φ₁, φ₂, b₁, b₂ can be obtained based on existing information (such as historical data, expert experience, and so on), and the representative frequencies, amplitudes, and initial phases for generating the simulated displacement signals of the shaft vibration can be selected based on the known ranges.

The simulated displacement data of the shaft vibration obtained based on several groups of simulated virtual measurements can be archived as a set of simulated data [Xᵥ, Yᵥ], where in each group of simulated virtual measurements, a group of virtual measurement data xᵥ and yᵥ are obtained by virtual simulated measurement with orthogonal measurement directions, and the group of virtual measurement data xᵥ and yᵥ are the respective values of the simulated displacement signals xᵥ(t) and yᵥ(t) of the shaft vibration as described above at a certain time instant.

The signal data set of the displacement signals of the shaft vibration of the sliding bearing in the rotating machinery obtained at step S101 can be at least a portion of the set of condition monitoring data [X_{c}, Y_{c}], can be at least a portion of the set of the simulated data [X_{V}, Y_{V}], or can be a set of signal data D_{raw}[X, Y] including at least a portion of the set of the condition monitoring data [X_{c}, Y_{c}] and/or at least a portion of the set of the condition monitoring data [X_{c}, Y_{c}].

Referring back to FIG. 1, at S102, the displacement signals of the shaft vibration in the signal data set can be classified and archived according to fault types.

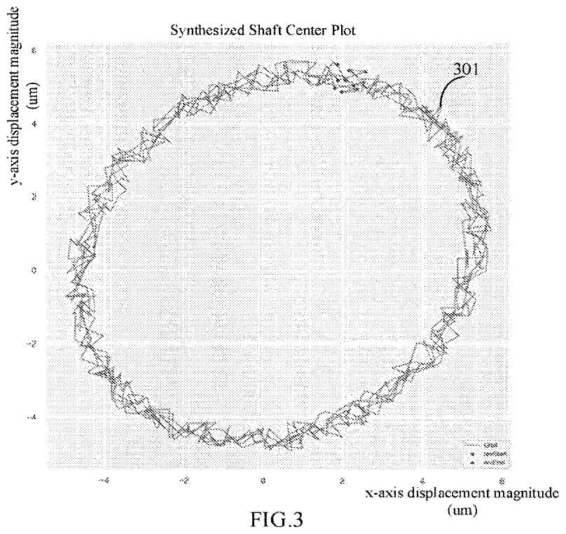

Different fault types can include, but are not limited to, normal, unbalance, misalignment, oil whip, oil whirl, scratch, rub, fluid-induced instability, preload, and so on. Different fault types can correspondingly have modes, symptoms, characteristics, and so on of the vibration signals in the time domain waveform, spectrum, and so on, as well as modes, symptoms, characteristics, and so on in the orbit plots of the shaft center. Here, a plot of the shaft center orbit can refer to a plan view showing the orbit of the shaft vibration, and the orbit of the vibration can be synthesized based on the vibration signals in the time domain. A non-limiting example of the orbit plots of the shaft center can be seen in FIG. 3, which will be discussed hereinafter in detail.

In the embodiments of the present disclosure, classifying and archiving the displacement signals of the shaft vibration in the signal data set according to the fault types can refer to sorting and summarizing the displacement signals of the shaft vibration in the signal data set into one or more corresponding sets according to one or more different fault types. Specifically, after classifying and archiving according to fault types, the signal data set of the displacement signals of the shaft vibration of the sliding bearing in the rotating machinery obtained at step S101 (such as at least a portion of the set of the condition monitoring data [X_{c}, Y_{c}], at least a portion of the set of the simulated data [X_{V}, Y_{V}], or the set of the signal data D_{raw}[X, Y] including at least a portion of the set of the condition monitoring data [X_{c}, Y_{c}] and/or at least a portion of the set of the simulated data [X_{V}, Y_{V}]) can thus be further refined into one or more sets of the patterned signal data D_{patterened}[X, Y].

At S103, the displacement signals in the archived signal data set can be synthesized to obtain a plot of the shaft center orbit of the sliding bearing in the rotating machinery, so as to obtain a plot data set of the shaft center orbit.

Specifically, in the embodiments according to the present disclosure, for one or more sets of the patterned signal data corresponding to one or more of the fault types, the displacement signals of the shaft vibration in each set of the patterned signal data D_{patterened}[X, Y] can be synthesized to obtain the plot of the shaft center orbit of the sliding bearing in the rotating machinery, so as to obtain a plot data set of the shaft center orbit.

However, it is to be understood that the displacement signals of the shaft vibration in other archived sets of signal data in addition to the sets of the patterned signal data D_{patterened}[X, Y] can also be synthesized to obtain the orbit plots of the shaft center of the sliding bearing in the rotating machinery, so as to obtain the data set of the orbit plots of the shaft center.

As non-limiting examples, the previously described sets of signal data (such as but not limited to at least a portion of the set of the condition monitoring data [X_{c}, Y_{c}], at least a portion of the set of the simulated data [X_{V}, Y_{V}], or the set of the signal data D_{raw}[X, Y] including at least a portion of the set of the condition monitoring data [X_{c}, Y_{c}] and/or at least a portion of the set of the simulated data [X_{V}, Y_{V}]) are archived as a signal data set D_{signal}, and the corresponding plot data set of the synthesized orbit of the sliding bearing in the rotating machinery is archived as a data set of orbit plots of the shaft center D_{image}. Through the process of classifying and archiving described above, the signal data in the signal data set D_{signal} can have corresponding fault types. Also, the data of the orbit plot of the shaft center in the corresponding data set of the orbit plot of the shaft center D_{image} can also have a corresponding fault type.

FIG. 3 shows a plot of the shaft center orbit of a sliding bearing in rotating machinery obtained by synthesizing the displacement signals in the two directions of the x-axis and the y-axis shown in FIG. 2 according to embodiments of the present disclosure.

As shown in FIG. 3, the horizontal axis of the orbit plot of the shaft center represents the displacement magnitude in the x-axis direction, and the vertical axis represents the displacement magnitude in the y-axis direction. The abscissa of a point on plot 301 in the plot of the shaft center orbit is the displacement magnitude in the x-axis direction at a certain time instant (such as the condition monitoring data x_{c} in a certain group of the condition monitoring data as described above, the virtual measurement data x_{V} in a certain group of the virtual measurement data as described above, and so on), the ordinate of the point the displacement magnitude on the y-axis at the same time instant (such as the condition monitoring data y_{c} in the same group of the condition monitoring data, the virtual measurement data y_{V} in the same group of the virtual measurement data of conditions). In other words, the coordinate in FIG. 3 can be regarded as a complex plane. For example, for the displacement signals of the shaft vibration x(t) and y(t), the plot of the synthesized shaft center orbit can be accordingly expressed as:

z(t)=x(t)+j y(t) (2)

It is to be understood that, in an ideal non-failure mode, the plot of the synthesized shaft center orbit should be a relatively standard circle.

A diagnostic knowledge base can be sorted out according to the on-site signal of the plots of the shaft center orbit and its corresponding fault type, and the diagnostic knowledge base includes typical fault diagnosis types and the characteristics of their corresponding displacement signals of the shaft vibration and plots of the shaft center orbit.

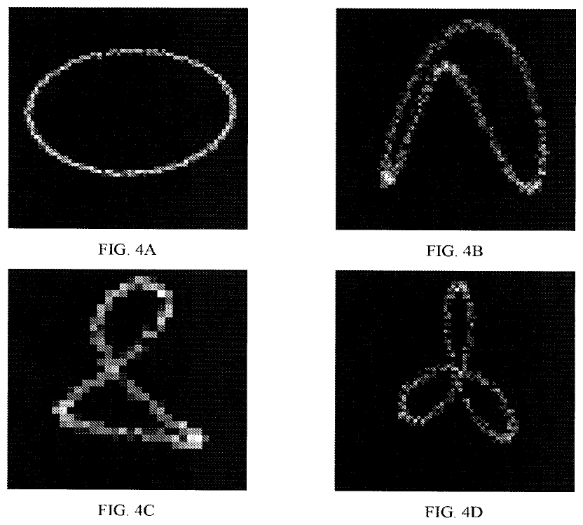

As a non-limiting example, FIGS. 4A to 4D show plots of the shaft center orbit of a sliding bearing in rotating machinery with four types of typical faults. Specifically, the oval-shaped orbit shown in FIG. 4A can correspond to the first fault type, the banana-shaped orbit shown in FIG. 4B can correspond to the second fault type, the 8-shaped orbit shown in FIG. 4C can correspond to the third fault type, and the petal-shaped orbit shown in FIG. 4D can correspond to the fourth fault type.

It is to be understood that FIG. 4A to FIG. 4D are only non-limiting examples, and the fault types preset or defined in this disclosure can only include some of the fault types, and can also include more other fault types that are not shown.

Referring back to FIG. 1, at S104, the fault diagnosis model can be trained based on the plot data set of the shaft center orbit. In embodiments of the present disclosure, the fault model can also be trained based on the signal data set and/or the plot data set of the shaft center orbit to fully utilize the signal features and/or image features.

In embodiments according to the present disclosure, training the fault diagnosis model can include further processing the archived signal data set D_{signal} and/or the plot data set of the shaft center orbit D_{image}.

Specifically, in case it is required to train a fault diagnosis model utilizing the signal data, signal processing can be performed on the signal data set to improve the data quality of the target signal analysis process. Signal processing can include but is limited to, denoising, filtering, detrending, enveloping, Fast Fourier Transform (FFT), Wavelet Transform (WT), Wavelet Packet Transform (WPT), and Empirical Mode Decomposition (EMD), and so on. The processed signal data set can be archived as D′_{signal}.

When it is necessary to use axis orbit plot data to train a fault diagnosis model, image processing can be performed on the plot data set of the shaft center orbit D_{image} to improve the data quality of the target image analysis process. Image processing can include but is not limited to shift, scaling, flip, rotation, deformation, denoising, compensation, and so on. The processed plot data set of the shaft center orbit can be archived as D′_{image}.

In embodiments according to the present disclosure, training the fault diagnosis model can further include extracting a set of signal features F_{signal} and/or a set of image features F_{image} form the processed signal data set D′_{signal} and/or the processed plot data set of the shaft center orbit D′_{image}.

Specifically, a relevant feature extraction algorithm can be used to extract the set of signal features F_{signal} from the processed signal data set D′_{signal}. The set of signal features F_{signal} can include one or more of the following features: time domain features, such as but not limited to the mean value, standard deviation, root mean square (RMS), peak-to-peak value, skewness, kurtosis, and so on; frequency domain features, such as but not limited to harmonic locations and amplitudes, and so on; time-frequency domain features, such as but not limited to WPT components 1-8, Intrinsic Mode Functions (IMF) components 1-8, invariant moment features 1-7, and so on; angle features, such as but not limited to angle monotonicity, and so on.

A relevant feature extraction algorithm can be used to extract the set of image features F_{image} from the processed plot data set of the shaft center orbit D′_{image}. The set of image features F_{image} includes one or more of the following features: geometric features, such as but not limited to area, perimeter, compactness, circularity, rectangularity, eccentricity, and so on; shape context features, such as but not limited to shape context, height function, AFHF1 shape descriptor, AFHF2 shape descriptor, inner-distance shape context, and so on; general image process features, such as but not limited to RGB values, HSV values, pixel matrices, and so on.

It is to be understood that the set of the signal features F_{signal} and the set of the image features F_{image} can also be extracted from the unprocessed signal data set D_{signal} and/or the plot data set of the shaft center orbit D_{image}.

In embodiments according to the present disclosure, the feature set finally used for modeling can include one or more features from the set of signal features F_{signal} and the set of the image features F_{image}, and the features to be used for training from the set of the signal features F_{signal} and the set of the image features F_{image} can be fused before training the fault diagnosis model with the features from the set of signal features F_{signal} and the set of the image features F_{image}.

In embodiments according to the present disclosure, training the fault diagnosis model can further include training the fault diagnosis model based on the extracted set of the signal features and the extracted set of the image features. In embodiments according to the present disclosure, the modeling process can include performing traditional machine learning modeling and deep learning modeling based on the extracted set of the signal feature and the extracted set of the image features, and fusing a machine learning model and a deep learning model, to obtain the fault diagnosis model that solves multi-classification problems.

Machine learning modeling can use one or more of the following algorithms: K-Nearest Neighbor (KNN), Naïve Bayes, Decision Tree, Random Forest, Support Vector Machine (SVM), XgBoost, LightGBM, BP Neural Network, and so on.

Deep learning modeling can use image recognition algorithms, such as convolutional neural networks (CNN), and so on. As a non-limiting example, in the case of deep learning, the present disclosure can omit image processing, feature extraction, and other processes, and directly input the plot of the shaft center or a part thereof into the CNN network for training or recognition.

Machine learning requires a relatively small amount of calculations and is less likely to suffer from overfitting, while deep learning has better learning effects. With model fusion, the advantages of the two types of learning can be advantageously utilized.

It is to be understood that the above enumerations are only non-limiting examples, and suitable algorithms other than deep learning and machine learning can be used to establish the fault diagnosis model in this disclosure.

The trained fault diagnosis model can be used to perform fault diagnosis based on displacement signals of shaft vibration of a sliding bearing in the rotating machinery to be diagnosed and output the possible fault types of the sliding bearing in the rotating machinery to be diagnosed. With the method 100 shown in FIG. 1, a fault diagnosis model can be obtained by modeling. The fault diagnosis model is established by combining signal features and image features, and can conduct comprehensive, fast, and accurate fault diagnosis and prediction. Moreover, after performing method 100, the fault diagnosis model can still be further trained and optimized. For example, the trained fault diagnosis model can be further trained and optimized using the data obtained in the diagnosis stage.

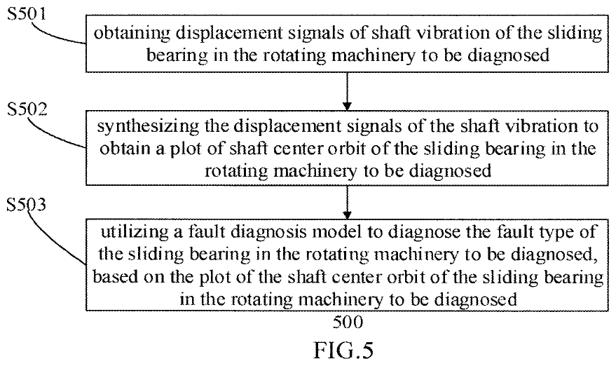

FIG. 5 shows a flowchart of method 500 for fault diagnosis of a sliding bearing in rotating machinery according to embodiments of the present disclosure.

As shown in FIG. 5, at S501, displacement signals of shaft vibration of the sliding bearing in the rotating machinery to be diagnosed can be obtained. It is to be understood that the displacement signals of the shaft vibration of the sliding bearing in the rotating machinery to be diagnosed can be obtained in the manner same as or similar to that used for the signal data set of the displacement signals of the shaft vibration of the sliding bearing in the rotating machinery described above with reference to S101 in FIG. 1 (for example, using the same module), also can be obtained in a different manner.

At S502, the displacement signals of the shaft vibration can be synthesized to obtain a plot of the shaft center orbit of the sliding bearing in the rotating machinery to be diagnosed. It is to be understood that the plot of the shaft center orbit of the sliding bearing in the rotating machinery to be diagnosed can be synthesized in the manner same as or similar to that used for the plot data set of the shaft center orbit described above with reference to S103 in FIG. 1 (for example, using the same module), also can be synthesized in a different manner.

At S503, a fault diagnosis model can be utilized to diagnose the fault type of the sliding bearing in the rotating machinery to be diagnosed, based on the plot of the shaft center orbit of the sliding bearing in the rotating machinery to be diagnosed.

In embodiments according to the present disclosure, in the case where the fault diagnosis model is a machine learning model, a deep learning model, or a fusion model thereof, the method 500 can also include one or more of the following steps: performing signal processing on the displacement signals of the shaft vibration and performing image processing on the plot of the shaft center orbit; extracting signal features and image features from the processed displacement signals of the shaft vibration and the processed plot of the shaft center orbit; and inputting the extracted signal features and image features into the fault diagnosis model to obtain the fault type of the sliding bearing in the rotating machinery to be diagnosed.

In embodiments according to the present disclosure, in addition to fault diagnosis, the model of the present disclosure can also be used for asset condition monitoring, fault prediction, and so on.

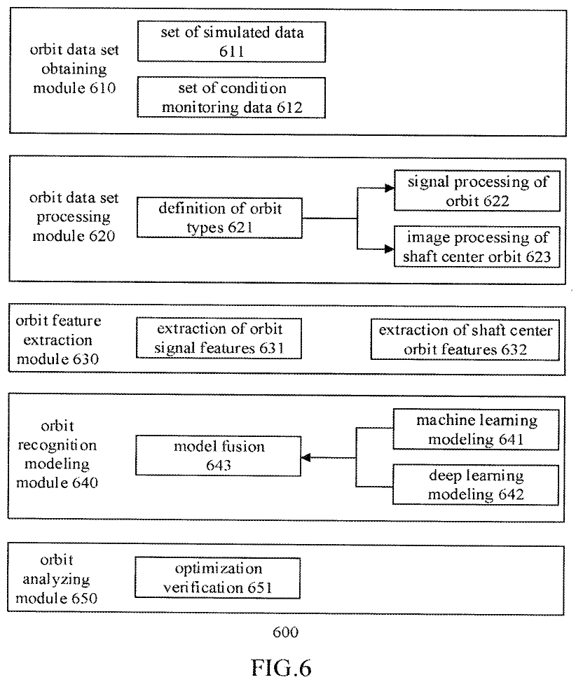

FIG. 6 shows a diagram of device 600 for establishing a fault diagnosis model of a sliding bearing in rotating machinery according to embodiments of the present disclosure. The device 600 can be applied to the modeling stage, for example, the stage corresponding to the method 100 shown in FIG. 1, and be configured for establishing a fault diagnosis model.

The device 600 can include an orbit data set obtaining module 610, configured to obtain a signal data set of displacement signals of shaft vibration of the sliding bearing in the rotating machinery. Specifically, the orbit data set obtaining module 610 can obtain a set of simulated data 611 by simulated virtual measurement, and/or obtain a set of condition monitoring data 612 by sensors and the like. It is to be understood that the orbit data set obtaining module 610 can be configured to obtain signal data sets including either or both of the set of the simulation data 611 and the set of the condition monitoring data 612 for use in subsequent modeling processes.

The device 600 can also include an orbit data set processing module 620 configured to classify and archive the displacement signals of the shaft vibration in the signal data set, including the set of the simulation data 611 and the set of the condition monitoring data 612, according to fault types, and to synthesize the displacement signals in the archived signal data set to obtain a plot of shaft center orbit of the sliding bearing in the rotating machinery, so as to obtain a plot data set of the shaft center orbit.

In addition, in the embodiments according to the present disclosure, the orbit data set processing module 620 can also be configured to perform the definition of orbit types 621 for defining the fault types for classifying and archiving the displacement signals of the shaft vibration in the signal data set according to the defined fault types. By performing the definition of orbit types 621, fault diagnosis based on user-defined fault types can be realized. For example, with the accumulation of experience or changes to the diagnostic requirements, the definition of orbit types 621 can be performed accordingly to update the fault types and the signal data set can be patterned based on the updated fault types, and the signal data sets patterned based on the updated default types and/or the corresponding orbit data sets can be used to train the fault diagnosis model, so that the resulting fault diagnosis model can diagnose updated fault types.

In embodiments according to the present disclosure, the orbit data set processing module 620 can also be configured to perform signal processing of orbit 622. Specifically, the signal processing can be performed on the signal data set to improve the data quality of the target signal analysis process.

In embodiments according to the present disclosure, the orbit data set processing module 620 can also be configured to perform image processing of shaft center orbit 623. Specifically, image processing can be performed on the plot data set of the shaft center orbit or plot data of the shaft center orbit to be diagnosed, to improve the data quality of the target image analyzing process.

The device 600 can further include an orbit feature extraction module 630 configured to perform extraction of orbit signal features 631 and extraction of shaft center orbit features 632. Specifically, the extraction of orbit signal features 631 can include using a relevant feature extraction algorithm to extract a set of signal features based on a signal data set, and the extraction of shaft center orbit features 632 can include using a relevant feature extraction algorithm to extract a set of image features based on a plot data set of shaft center orbit.

The device 600 can further include an orbit recognition modeling module 640 that can be configured to train a fault diagnosis model based on the archived signal data set and/or the plot data set of shaft center orbit. Specifically, the orbit recognition modeling module 640 can be configured to perform machine learning modeling 641 and deep learning modeling 642, and perform model fusion 643 based on machine learning modeling 641 and deep learning modeling 642.

The device 600 can also include an orbit analyzing module 650 that can be configured to perform an optimization verification 651 for optimizing the modeling based on the verification process. Specifically, the orbit analyzing module can be configured to verify and optimize the fault diagnosis model obtained by the orbit recognition modeling module 640 based on the plot data set of the shaft center orbit labeled with the respective fault type and/or the archived signal data set (e.g., the patterned signal data set D_{patterened}[X, Y]) to improve the accuracy of the model.

It is to be understood that the modules in the device 600 used in the modeling stage shown in FIG. 6 are just exemplary, and one or more of the modules can be omitted, or one or more of the functions performed in each module can be omitted. Of course, the device 600 can also include more modules not shown, and perform more functions not shown.

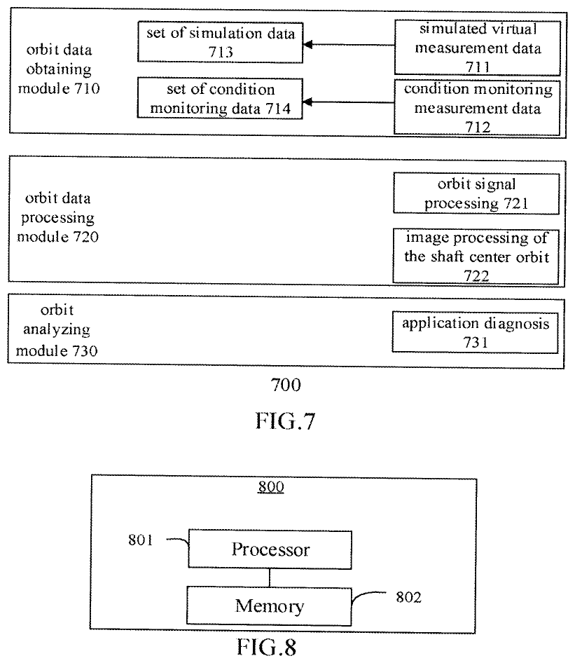

FIG. 7 shows a diagram of device 700 for fault diagnosis of a sliding bearing in rotating machinery according to embodiments of the present disclosure. The device 700 can be applied in the diagnosis stage, for example, the stage corresponding to the method 500 shown in FIG. 5, and is configured for fault diagnosis of a sliding bearing in rotating machinery to be diagnosed.

The device 700 can include an orbit data obtaining module 710 that can be configured to obtain displacement signals of shaft vibration of the sliding bearing in the rotating machinery to be diagnosed. Specifically, the orbit data obtaining module 710 can obtain simulated virtual measurement data 711 and /or condition monitoring measurement data 712.

In embodiments according to the present disclosure, the orbit data obtaining module 710 can also optionally incorporate the obtained simulated virtual measurement data 711 and/or the condition monitoring measurement data 712 into the set of simulation data 713 and the set of condition monitoring data 714 obtained during the modeling phase, for further optimization of the diagnostic model.

The device 700 can also include an orbit data processing module 720 that can be configured to synthesize the shaft center orbit plot of the sliding bearing in the rotating machinery to be diagnosed based on the displacement signals of the shaft vibration of the sliding bearing in the rotating machinery to be diagnosed.

In embodiments according to the present disclosure, the orbit data processing module 720 can also be configured to perform orbit signal processing 721. Specifically, signal processing can be performed on the displacement signals of the shaft vibration of the sliding bearing in the rotating machinery to be diagnosed to improve the data quality of the target signal analysis process.

In embodiments according to the present disclosure, the orbit data processing module 720 can also be configured to perform image processing of the shaft center orbit 722. Specifically, image processing can be performed on the plot of the shaft center orbit of the sliding bearing in the rotating machinery to be diagnosed, to improve the data quality of the target image analysis process.

The device 700 can also include an orbit analyzing module 730 that can be configured to perform application diagnosis 731, that is, based on the displacement signals of the shaft vibration and/or the plot of the shaft center orbit of the sliding bearing in the rotating machinery to be diagnosed, using the fault diagnosis model (for example, the fault diagnosis model established by the aforementioned device 600) to obtain the fault type of the sliding bearing in the rotating machinery to be diagnosed.

In embodiments according to the present disclosure, although not shown in FIG. 7, the device 700 can further include an orbit feature extraction module 740 that can be configured to perform extraction of orbit signal features 741 (not shown) and extraction of shaft center orbit features 742 (not shown). Specifically, the extraction of orbit signal features 741 can include using a relevant feature extraction algorithm to extract signal features based on the displacement signals of the shaft vibration of the sliding bearing in the rotating machinery to be diagnosed, and the extraction of shaft center orbit plot features 742 can include using a relevant feature extraction algorithm to extract image features based on the plot data of the shaft center orbit of the sliding bearing in the rotating machinery to be diagnosed.

It is to be understood that each module in the device 700 used in the diagnosis stage shown in FIG. 7 is only an example, and one or more of the modules can be omitted, or one or more functions performed in each module can be omitted. Of course, the device 700 can also include more modules not shown, and perform more functions not shown.

It is to be understood that the device 600 shown in FIG. 6 used in the modeling phase and the device 700 shown in FIG. 7 used in the diagnosis phase can be different devices, or they can be the same device, to advantageously achieve closed-loop monitoring, evaluation, and improvement in the same device. Furthermore, modules in the device 600 and the device 700 with similar functions can be different modules, or they can be the same module. For example, the orbit data set obtaining module 610 and the orbit data obtaining module 710 can be different modules, or they can be the same module, and the orbit data set processing module 620 and the orbit data processing module 720 can be different modules, or they can be the same module.

FIG. 8 shows a diagram of device 800 for fault diagnosis of a sliding bearing in rotating machinery according to embodiments of the present disclosure. As shown in FIG. 8, the device 800 can include a processor 801 and a memory 802.

Processor 801 can be any device with processing capabilities for implementing the functions of the various embodiments of the present disclosure. For example, it can be a general-purpose processor, a digital signal processor (DSP), an ASIC designed to perform the functions described herein, a field programmable gate array (FPGA), or other programmable logic device (PLD), discrete gate or transistor logic, discrete hardware components, or any combination thereof.

Memory 802 can include computer system-readable media in the form of volatile memory, such as random access memory (RAM) and/or cache memory, as well as other removable/non-removable, volatile/nonvolatile Computer system memory, such as a hard drive, floppy disk, CD-ROM, DVD-ROM, or other optical storage media.

In this embodiment, computer program instructions are stored in the memory 802, and the processor 801 can execute the instructions stored in the memory 802. When the computer program instructions are performed by the processor, the processor is caused to perform the method for fault diagnosis of sliding bearings in rotating machinery according to embodiments of the present disclosure. The method for fault diagnosis of sliding bearings in rotating machinery is basically the same as that described above with respect to FIGS. 1-5, and therefore will not be described again in order to avoid repetition.

The method/device for fault diagnosis of sliding bearings in rotating machinery according to the present disclosure can also be implemented by a computer program product containing a program code for implementing the method or device, or by any memory medium storing such a computer program product.

The present disclosure provides a method and device for fault diagnosis of sliding bearings in rotating machinery based on machine learning, providing advantages including:
utilizing the advantages of engineering knowledge, machine learning algorithms and big data technology to fully mine features from shaft vibration signals for accurate and rapid insight for fault diagnosis;
based on the characteristics of the shaft vibration signal and the two-dimensional plot of shaft center orbit synthesized from the shaft vibration signals, analyzing from different angles using multiple technologies to obtain more comprehensive information and better performance;
being able to monitor, evaluate and improve rotating machinery, especially rotating machinery with sliding bearings, in a continuously closed loop, thereby greatly enhancing related product performance, service ability and solution capability to support more adaptive solution offers in a data-driven, knowledge-driven digitalized and intelligent way and create data-driven and knowledge-driven health prediction and management system based on expert knowledge and experience.

Various changes, substitutions and alterations to the technology described herein can be made without departing from the teaching of the technology as defined by the appended claims. Moreover, the scope of the claims of the present disclosure is not limited to the specific aspects of the process, machine, manufacture, composition of matter, means, method and acts described above. Any process, machine, manufacture, composition of matter, means, method or act, currently existing or later developed, which performs substantially the same function or achieves substantially the same result as the corresponding aspect described herein can be utilized. Accordingly, the appended claims include within their scope such processes, machines, manufacture, compositions of matter, means, methods, or acts.

The above description of the disclosed aspects is provided to enable any person skilled in the art to make or use the disclosure. Various modifications to these aspects will be readily apparent to those skilled in the art, and the generic principles defined herein can be applied to other aspects without departing from the scope of the disclosure. Therefore, the present disclosure is not intended to be limited to the aspects shown herein but is to be accorded the widest scope consistent with the principles and novel features disclosed herein.

The foregoing description has been presented for illustration and description. Furthermore, this description is not intended to limit the embodiments of the present disclosure to the form disclosed herein. Although various example aspects and embodiments have been discussed above, those skilled in the art will conceive of certain variations, modifications, changes, additions and sub-combinations thereof.

What is claimed is:

1. A method of establishing a fault diagnosis model for a sliding bearing in rotating machinery, the method comprising:
obtaining a signal data set of displacement signals of shaft vibration of the sliding bearing in the rotating machinery;
classifying and archiving the displacement signals of the shaft vibration in the signal data set according to fault types;
synthesizing the displacement signals in the archived signal data set to obtain a plot of shaft center orbit of the sliding bearing in the rotating machinery, so as to obtain a plot data set of the shaft center orbit; and
training the fault diagnosis model based on the plot data set of the shaft center orbit.

2. The method of claim 1, wherein the signal data set includes at least one of a set of simulated data and a set of condition monitoring data, the set of simulated data includes data obtained by virtual measurements with simulated measurement directions that are orthogonal to each other, and the set of the condition monitoring data include data obtained by two sensors with measurement directions that are orthogonal to each other.

3. The method of claim 1, wherein training fault diagnosis model based on the plot data set of the shaft center orbit comprises:
extracting a set of signal features based on the archived signal data set, and extracting a set of image features based on the plot data set of the shaft center orbit; and
training the fault diagnosis model based on the extracted set of the signal features and the extracted set of the image features.

4. The method of claim 3, wherein training the fault diagnosis model based on the extracted set of the signal features and the extracted set of the image features comprises:
performing machine learning modeling and deep learning modeling based on the the extracted set of the signal features and the extracted set of the image features;
fusing a machine learning model and a deep learning mode to obtain the fault diagnosis model.

5. A device for fault diagnosis of a sliding bearing in rotating machinery, the device comprising:
a memory having computer instructions stored thereon; and
a processor,
wherein the instructions, when executed by the processor, cause the processor to perform a method of claim 1.

6. A non-transitory computer-readable storage medium storing instructions that cause a processor to perform the method of claim 1.

7. A device for fault diagnosis of a sliding bearing in rotating machinery, the device comprising:
a memory having computer instructions stored thereon; and
a processor,
wherein the instructions, when executed by the processor, cause the processor to perform a method of claim 4.

8. A non-transitory computer-readable storage medium storing instructions that cause a processor to perform the method of claim 4.

9. A method for fault diagnosis of a sliding bearing in rotating machinery, the method comprising:
obtaining displacement signals of shaft vibration of the sliding bearing in the rotating machinery to be diagnosed;
synthesizing the displacement signals of the shaft vibration to obtain a plot of shaft center orbit of the sliding bearing in the rotating machinery to be diagnosed;
utilizing a fault diagnosis model to diagnose the fault type of the sliding bearing in the rotating machinery to be diagnosed, based on the plot of the shaft center orbit of the sliding bearing in the rotating machinery to be diagnosed.

10. The method of claim 9, wherein in case the fault diagnosis model is a machine learning model, a deep learning model or a fusion model thereof, the method further includes:
extracting signal features based on the displacement signals of the shaft vibration, and extracting image features based on the plot of the shaft center orbit; and
inputting the extracted signal features and image features into the fault diagnosis model to diagnose the fault type of the sliding bearing in the rotating machinery to be diagnosed.

11. A device for fault diagnosis of a sliding bearing in rotating machinery, the device comprising:
a memory having computer instructions stored thereon; and
a processor,
wherein the instructions, when executed by the processor, cause the processor to perform a method of claim 9.

12. A non-transitory computer-readable storage medium storing instructions that cause a processor to perform the method of claim 9.

13. A device for establishing a fault diagnosis model of a sliding bearing in rotating machinery, the device comprising:
an orbit data set obtaining module configured to obtain a signal data set of displacement signals of shaft vibration of the sliding bearing in rotating machinery;
an orbit data set processing module configured to:
classify and archive the displacement signals of the shaft vibration in the signal data set according to fault types, and
synthesize the displacement signals in the archived signal data set to obtain a plot of shaft center orbit of the sliding bearing in the rotating machinery, so as to obtain a plot data set of the shaft center orbit; and
an orbit identification modeling module configured to train the fault diagnosis model based on the plot data set of the shaft center orbit.

14. A device for fault diagnosis of a sliding bearing in rotating machinery, the device comprising:
an orbit data obtaining module configured to obtain displacement signals of shaft vibration of the sliding bearing in the rotating machinery to be diagnosed;
an orbit data processing module configured to synthesize the displacement signals of the shaft vibration to obtain a plot of shaft center orbit of the sliding bearing in the rotating machinery to be diagnosed; and
an orbit analysizing module configured to utilize a fault diagnosis model to diagnose the fault type of the sliding bearing in the rotating machinery to be diagnosed, based on the plot of the shaft center orbit of the sliding bearing in the rotating machinery to be diagnosed.

15. A device for fault diagnosis of a sliding bearing in rotating machinery, the device comprising:
a memory having computer instructions stored thereon; and
a processor,
wherein the instructions, when executed by the processor, cause the processor to perform a method of claim 10.

16. A non-transitory computer-readable storage medium storing instructions that cause a processor to perform the method of claim 10.
